(19) United States
(12) Patent Application Publication
(10) Pub. No.: US 2025/0291333 A1
(43) Pub. Date: Sep. 18, 2025

(54) SELF-LEARNING PROCESS FOR A MANUFACTURING AND/OR ASSEMBLY PROCESS

(71) Applicant: Carl Zeiss AG, Oberkochen (DE)

(72) Inventors: Matthias Karl, Koenigsbronn (DE); Carsten Glasenapp, Oberkochen (DE)

(21) Appl. No.: 19/224,302

(22) Filed: May 30, 2025

Related U.S. Application Data
(63) Continuation of application No. PCT/EP2023/083627, filed on Nov. 29, 2023.

(30) Foreign Application Priority Data
Dec. 1, 2022 (DE) 10 2022 131 925.3

(51) Int. Cl. G05B 19/4097

(52) U.S. Cl. CPC G05B 19/4097; G05B 2219/35134

(57) ABSTRACT

A computer-implemented method is for generating reference data for use in a manufacturing and/or assembly process. The method may include, as a method step, obtaining a digital model of a workpiece. Herein, the digital model may be, in particular, a 3D model. The digital model may also be, in particular, a CAD model. The workpiece may be, in particular, an assembled workpiece. In another step, the method may include obtaining video data of the manufacturing and/or assembly process of the workpiece. Furthermore, the method may include generating a digital flowchart of the manufacturing and/or assembly process based at least in part on the digital model and the video data.

### CROSS-REFERENCE TO RELATED APPLICATIONS

This application is a continuation application of international patent application PCT/EP2023/083627, filed Nov. 29, 2023, designating the United States and claiming priority from German application 10 2022 131 925.3, filed Dec. 1, 2022, and the entire content of both applications is incorporated herein by reference.

### TECHNICAL FIELD

The present disclosure relates generally to the technical field of industrial manufacturing and more particularly to a computer-implemented method of generating reference data for use in a manufacturing and/or assembly process.

### BACKGROUND

Self-learning processes have many applications in industry.

US 2020/0409383 A1 discloses a method that provides robust metric reports based on the analysis of video data. The method uses learning-based methods for object identification, object localization and context analysis to gain insights into, for example, efficiency, productivity, design and planning, and compliance with health and safety regulations in a work environment.

An overview of other self-learning methods is provided in the following scientific publication: Olivares-Alarcos, Alberto, et al. “A review and comparison of ontology-based approaches to robot autonomy.” The Knowledge Engineering Review 34 (2019).

In today's self-learning methods for manufacturing and/or assembly processes, “teach methods” are usually used, that is, a motion sequence is first detected and later replicated identically by the machine. When the sequence is reproduced by the system, however, adaptation to changing boundary conditions or self-optimization is not readily possible. This makes such processes rigid and inflexible.

Furthermore, the processes mentioned must be specially adapted to a system or machine. With a large number of different machines, the adaptation or machine-specific programming leads to high effort and costs.

Accordingly, there is a need for a process that is simpler and therefore more flexible. Such an improved process is also of great interest for frequently changing, flexible production and small series, as the effort involved is particularly high compared to the utilization (time).

### SUMMARY

It is therefore an objective of the present disclosure to provide an improved method of manufacturing and/or assembly processes and thus to overcome, at least in part, the above-mentioned disadvantages of the prior art.

This objective is solved by various embodiments of the disclosure. In its most general form, the disclosure relates to a computer-implemented method of generating reference data for use in a manufacturing and/or assembly process. The method may include, as a method step, obtaining a digital model of a workpiece. Herein, the digital model may, in particular, be a 3D model. The digital model may, in particular, also be a CAD model. In particular, the workpiece may be an assembled workpiece. In a further step, the method may include obtaining video data of the manufacturing and/or assembly process of the workpiece. Furthermore, the method may include generating a digital flowchart of the manufacturing and/or assembly process based at least in part on the digital model and/or the video data.

The method may be used for autonomous learning of a system or machine. The method may also be used to implement self-learning manufacturing and/or assembly lines.

Reference data may include the digital flowchart or parts of the digital flowchart. Reference data may be used in a variety of ways. For example, reference data may be translated into control protocols of systems. It is also possible for control protocols of systems to include at least part(s) of the reference data. Reference data may be used for autonomous learning in the manufacturing and/or assembly process.

A manufacturing and/or assembly process can be understood as any type of manufacture or assembly of a workpiece. It may, for example, be a shaping process. It may also be the assembly, creation or testing of a workpiece. The manufacturing and/or assembly process may also involve assembling, packaging, screwing, gluing, riveting, clicking, drilling, sawing, cutting and/or welding. It may also be a combination of the aforementioned processes. Accordingly, the process may have a large number of process steps. A manufacturing and/or assembly process may be an overall process or a sub-process of a more complex process.

A digital model is generally understood by the person skilled in the art to mean a computerized data model of a building, product or other object, the computerized data model describing the shape of a real existing or planned object. A digital model may include all necessary data associated with the object. The digital model may be stored on a storage medium. In the aspect described above, the object represented by the digital model is a workpiece. As described at the beginning, the workpiece or object may be a composite workpiece or object. The digital model may therefore also include a (virtual) combination of several (matching) individual components. In this respect, the digital model may combine several different workpieces or objects, for example four (wooden) beams and a (wooden) board, which together form a table.

CAD (computer-aided design) is usually understood to mean the computer-aided creation and modification of geometric models. In addition, CAD is understood to mean all computer-aided activities in a design process, including geometric modeling, calculation, simulation and other information acquisition and information provision. A CAD model is therefore usually understood by the skilled person to be a model that has been created by a computer-aided activity.

A workpiece may generally be understood to be a single delimited part of generally solid material that is processed in some way. The workpiece may be made at least partly of metal, wood and/or plastic. The workpiece may include several components.

An assembled workpiece can be understood as a workpiece that includes a plurality of components, whereby the components are connected to each other by inserting, clamping, screwing or a similar method.

The video data may be detected or obtained with at least one camera. The camera may be a depth camera, for example. The camera may be intrinsically or extrinsically calibrated. The video data may also be obtained in real time. It is also possible that several cameras from different perspectives are used in the method. The use of multiple cameras may advantageously avoid shadowing.

The video data may include recordings of human activities during a manufacturing and/or assembly process. The human activities may, for example, include all processes that are necessary for the manual manufacture and/or assembly of a workpiece. The activities may involve drilling or sawing, for example. The video data may also include the tools required for the activity, that is, a drill or saw, for example. It is of course also possible for the video data to include recordings of activities performed by a machine.

The video data may also include recordings of virtual objects. It is conceivable that the manufacturing and/or assembly processes are performed in a virtual environment or in an enlarged or scaled-down model environment. For example, aircraft manufacturing may be recorded on a scaled-down model. In contrast, processes in electron microscopes or microsystems technology could be recorded in enlarged environments.

The video data may be processed algorithmically online or offline. Relevant information may be extracted through the processing. In a first step, for example, objects, items and/or persons and/or their action(s), work(s) and/or manual activities may be recognized in the video data. In a further step, manufacturing and/or assembly steps or the phases and type of manufacturing and/or assembly steps may then be recognized, respectively. In a further step, the position or pose of relevant parts and objects, such as tools, may be detected and tracked.

Recognizing objects in the video data may be performed using techniques known today. This may include tracking objects and calculating the position and orientation of an object from video data. Both conventional algorithms (using edge, outline or texture detection) and algorithms based on machine learning (estimation of key features in the overall appearance) may be used. The recognition of objects or specific parts may also be carried out on the basis of CAD models, for example, by machine learning models such as a CNN (“convolutional neural network”), trained using synthetic data. The (synthetic) training data may also be generated on the basis of the CAD models. Various techniques may be used for this, as explained below in connection with machine learning models.

According to a further aspect of the disclosure, algorithms may also be used that recognize relationships between recognized objects or actions (semantic interpretation/scene graphs, ontology, for example, “FOON” functional object-oriented network). For example, an object recognizer may identify a tool in the video data. It is also possible to recognize where the tool is located in space and in what relation to other objects. In addition, a statement about the activity may be extracted (for example, tool in use or tool under repair).

The digital flowchart may include descriptions of an assembly, shaping and/or testing that a worker, machine and/or other agent would need to perform when assembling, creating and/or testing one or more workpieces. The digital flowchart may include at least one single step or any (finite) number of single steps. The digital flowchart may include a construction plan or a sequence of individual assembly steps. The digital flowchart may include detecting the position of components in the final assembly, the use and handling of tools or aids, for example a torque wrench, the checking and testing of intermediate steps and/or the correction of errors. The errors may be, for example, misalignment, incorrect drilling or deburring. The digital flowchart may also include interactions between people and machines.

The digital flowchart may be machine-independent and/or platform-independent. Furthermore, the digital flowchart may be available at least in part in the form of the Ontology Based Knowledge Representation, for example as a (dynamic) scene graph. It is also possible for the digital flowchart to be available at least in part in the form of the Unified Modeling Language (UML). The digital flowchart may include all the information required to provide the workpiece. A higher-level computing system may evaluate whether a particular system or a particular machine has sufficient degrees of freedom to execute the digital flowchart. For example, requirements from the digital flowchart and the description of the system or machine may be compared. The information on the kinematics may be available in the Unified Robot Description Format (URDF), for example.

A machine-independent digital flowchart may be translated into a route description for a system or a machine. In particular, the digital flowchart may be translated into a CAM (“computer aided manufacturing”) machine plan. This translation may be performed both in advance and during operation. The translation during operation may lead to an intuitive reaction of the machine during the process. In other words, the digital flowchart may be a universal and machine-independent plan for the manufacturing and/or assembly process.

A digital flowchart may of course be edited manually by describing the individual work steps in a defined format. It is also possible for the digital flowchart to be created automatically in its entirety or in parts.

The digital flowchart may be saved digitally. For each individual phase of the manufacturing and/or assembly process, the duration, the recognized component status before or after completion of the phase, the components used and the aids and tools used may be saved. The digital flowchart may also be stored as a tree structure analogous to an assembly priority graph. The storage structure may be in an open and platform-independent XML file format, for example. The use of templates or the use of different templates for different phases or steps is also possible. For example, the digital flowchart may include fixing or screwing, whereby the fixing or screwing includes information on the position of the screws (also from the CAD model), sequence of screwing, screw type, size, length and tool. The tool may be automatically assignable based on screw type and/or torque. The digital flowchart may also include references and links to the CAD data of the specific individual components, respectively.

Upon reproduction of the flowchart by the system or the machine, an adaption to changing boundary conditions or a self-optimization is possible. For example, movement sequences may be corrected independently based on video data and/or sensor signals. The flowchart may be evaluated in a target-oriented manner. For example, in the case of an imperfect movement trajectory, the movement can be smoothed or de-jerked in the digital flowchart so that it no longer contains any jitter or other influences or at least reduces them.

An advantage of the digital flowchart may be that a system or machine with sufficient degrees of freedom may perform different sequences without the system or machine having to be programmed in a machine-specific or machine-adapted way.

In an aspect of the disclosure, the step of generating the digital flowchart may include identifying a plurality of process steps of the manufacturing and/or assembly process based at least in part on the video data and preferably based on the digital model of the workpiece. Furthermore, the step of generating the digital flowchart may also include segmenting the video data, preferably using the digital model of the workpiece, to obtain information. In particular, the segmentation may be a semantic segmentation. The information may be information about the workpiece, information about at least one component of the workpiece, information about at least one executed process step, information about at least one tool used, information about at least one agent participating in the manufacturing and/or assembly process and/or information about a background represented in the video data.

The information may include the type and/or duration in each case. For example, the information about the at least one executed process step may include the type of process step and the duration of the process step.

Segmentation can be understood as the creation of content-related regions in image or video data by combining neighboring pixels or voxels according to a certain homogeneity criterion.

In an aspect of the disclosure, a computer-implemented method of controlling and/or performing feedback-control and/or inspecting a manufacturing and/or assembly process is provided. In a step, an actual state in the manufacturing and/or assembly process may be detected at least in part based on video data of the manufacturing and/or assembly process. In a further step, a deviation of the actual state from a target state may be detected. The target state may include reference data for the manufacturing and/or assembly process. In particular, the reference data may include a digital flowchart generated in accordance with one of the methods described herein. A further step may include generating an inspection result. Additionally or alternatively, a further step may include generating a work instruction for an agent.

An agent may be a human, a software, a robotic system or a machine. The work instruction may, for example, be included in a control signal that is configured to control an agent in the form of a robotic system, a machine, software or another type of automatically or semi-automatically controllable device. If the agent is a human, an inspection result may be displayed on a (digital) display device, for example.

In an aspect of the disclosure, a computer-implemented method of creating an AR environment is provided. The AR environment may be created based on reference data and the reference data may include, in particular, a digital flowchart generated according to one of the methods described herein.

AR (“augmented reality”) is usually understood to be a computer-supported extension of the perception of reality. This information may appeal to all human sensory modalities. In particular, AR can be understood as the visual representation of information, that is, the supplementation of images or videos with computer-generated additional information or virtual objects (so-called AR objects) via superimposition/overlay. An AR environment may be a virtual and computer-based environment with which a user can interact.

In an aspect of the disclosure, a further step of the methods described herein is to obtain additional data.

Additional data may be detected using various sensors and, if necessary, superimposed in a time-synchronous manner. Sensors and/or modalities for this additional data may include: haptic sensors, force and/or torque sensors, pressure sensors, acceleration sensors (IMUs), vibration sensors, microphones, ultrasonic detectors, infrasound detectors, each for recording airborne and/or structure-borne sound. Sound and/or voice data may include, for example, natural speech as instructions from a worker during a work step, such as “Screw part A flush to part B”. Additional data may represent individual values (target values) and/or values over time. An example of a target value is the torque with which a screw is to be fastened. Progression values are, for example, a force-displacement curve when clicking into a grid and the required pressure force up to clicking into place. “Smart” tools, devices or other equipment may be used herein, for example a networked torque wrench. Such a torque sensor/wrench can measure the torque achieved electrically and/or digitally and make it available to a networked or higher-level computing system.

Such a smart device or an (additional) data source may also be used in addition to the video data. For example, the networked torque wrench may serve as an (additional) data source so that, in addition to the video data and/or information extracted from the video data (for example, “tool/wrench is being used”), further information may also be included (for example, “torque wrench detects x Newton meters as torque at this point in time”).

In an aspect of the disclosure, a further step of the methods described herein is an adaptation of the digital flowchart by a user.

The adaptation may include, for example, a correction by the user. The user may pause the displayed information processing or the video data.

A manual correction of a recognized object may also be performed. The correction may be carried out by overlaying the information from the recorded video.

A simplified correction may also be performed, for example, via alternative suggestions in one or more drop-down list(s) of a recognized object. A drop-down list filled with components and tools of similar probability in the automated detection is also conceivable. The drop-down list may also be filled with other available components or stored CAD models.

Adaptation by the user may also include a priori information. It is possible that a recalculation of the information processing is carried out with this a priori information. For example, it is possible that components are incorrectly recognized or assigned in automatic processing. With the new a priori information from the user, a new pose determination can be carried out. This may also involve adapting a different or corrected CAD model.

It is also possible for the user to manually correct parameters in an automatically completed template, especially XML files.

Furthermore, the user can make additions to missing entries in templates, especially in XML files. For example, the screw size or type may be specified by the user if it has not been automatically recognized. Furthermore, a required torque may be specified by the user if no torque wrench with interface is used.

The data may be revised or corrected on a specially configured user interface that enables intuitive operation and/or graphically facilitates the steps and/or interaction with the software (GUI).

A user can be understood as a person who is involved in the manufacturing and/or assembly process. For example, the user may be a machine operator or a worker who processes the workpiece.

In an aspect of the disclosure, a further step of the methods described herein is to generate an animation based on the digital flowchart.

It is also possible for an animation to be created from the reference data. Generally speaking, an animation may include, for example, video data, video sequences, drawings, and/or sound documents. Preferably, an animation includes video data based on 3D models that do not correspond to the real image, that is, synthetically generated video data. For example, animations may be created based on CAD models using software conventionally used for this purpose, such as Blender or Unreal Engine. Animations may be displayed from different perspectives, that is, when an animation is played, the camera may be placed in the desired perspective and/or zoom level, focal length or magnification level. Animations may also be created using movement trajectories, with the same or increased speed during the process or even with incomplete information, for example, on the torque of the screw connection. The animations may be used as instructions or for training users and/or machine operators. The animation may include instructions for people to create, check or correct a component. The animation may be provided as augmented information (using AR glasses, laser tracker and/or video projector), mixed reality, sound (acoustic description using voice or warning auxiliary sounds) and/or haptic information.

In an aspect of the disclosure, in a further step, there may be provided a generation of one or more control signals for controlling a manufacturing and/or assembly system and/or for controlling a robotic system. Furthermore, in a further step, control of a manufacturing and/or assembly system and/or control of a robot system for manufacturing and/or assembling a workpiece may be provided using the digital flowchart and/or the one or more control signals.

It is also possible that, in a further step, generation of one or more control signals for controlling a manufacturing and/or assembly system and/or for feedback-control of a robot system may be provided. Furthermore, in a further step, control of a manufacturing and/or assembly system and/or feedback-control of a robot system for manufacturing and/or assembling a workpiece may be provided using the digital flowchart and/or the one or more control signals.

In another aspect of the disclosure, there is provided a computer program including instructions which, when the program is executed by a computer, cause the computer to perform one of the methods described herein.

In a further aspect of the disclosure, there is provided a device or system for data processing including means for carrying out the methods described herein. The means may in particular include: a camera, a sensor, an evaluation device, a control device and/or any combinations thereof, and/or further any devices mentioned further below in the embodiments in the context of the monitoring system explained therein.

The processes described above may be used in a variety of application fields. The fields of application include, for example, industrial assembly, assembly, manufacturing processes, plant construction and medical or biological laboratories. The methods described above may also be used to monitor work processes, in particular a manufacturing and/or assembly process.

Furthermore, a variety of systems, machines or components may be used in the above-mentioned processes. These include, for example, cameras, 3D sensors, strip projectors, laser line scanners, lidar, sensors for force or torque, industrial robots, articulated robot arms, Scara robots, linear actuators, collaborative robots, multi-robots, android robots and camera-based robot controllers. Human Machine Interfaces (HMI) may also be used in the processes. HMIs may typically include displays, computer mice, AR/VR glasses, haptic gloves and/or head, eye and body trackers.

The reference data may be generated using a machine learning model. The digital flowchart may also be generated using a machine learning model.

Furthermore, it is also possible that other process steps are based on the use of a machine learning model or machine learning algorithm. Machine learning may refer to algorithms and statistical models that computing systems can use to perform a particular task without using explicit instructions, rather than relying on models and inference. For example, machine learning may use a transformation of data that can be derived from an analysis of historical and/or training data, rather than a transformation of data based on rules. For example, the content of images may be analyzed using a machine learning model or using a machine learning algorithm. In order for the machine learning model to analyze the content of an image, the machine learning model may be trained using training images as input and training content information as output. By training the machine learning model with a large number of training images and/or training sequences (for example, words or sentences) and associated training content information (for example, labels or annotations), the machine learning model “learns” to recognize the content of the images so that the content of images not included in the training data can be recognized using the machine learning model. The same principle may also be used for other types of sensor data: By training a machine learning model using training sensor data and a desired output, the machine learning model “learns” a transformation between the sensor data and the output, which may be used to provide an output based on non-training sensor data provided to the machine learning model. The provided data (for example, sensor data, metadata and/or image data) may be pre-processed to obtain a feature vector, which is used as input to the machine learning model.

Machine learning models may be trained using training input data. The above examples use a training method called supervised learning. In supervised learning, the machine learning model is trained using a plurality of training samples, where each sample may include a plurality of input data values and a plurality of desired output values, that is, each training sample has a desired output value associated with it. By specifying both training samples and desired output values, the machine learning model “learns” which output value to provide based on an input sample that is similar to the samples provided during training. In addition to supervised learning, semi-supervised learning may also be used. In semi-supervised learning, some of the training samples lack a desired output value. Supervised learning can be based on a supervised learning algorithm (for example, a classification algorithm, a regression algorithm or a similarity learning algorithm). Classification algorithms may be used when the outputs are restricted to a limited set of values (categorical variables), that is, the input is classified as one of the limited set of values. Regression algorithms may be used when the outputs are any numerical value (within a range). Similarity learning algorithms can be similar to both classification and regression algorithms, but are based on learning from examples using a similarity function that measures how similar or related two objects are. In addition to supervised learning or semi-supervised learning, unsupervised learning may be used to train the machine learning model. In unsupervised learning, (only) input data may be provided and an unsupervised learning algorithm may be used to find a structure in the input data (for example, by grouping or clustering the input data, finding similarities in the data). Clustering is the assignment of input data including a plurality of input values into subsets (clusters) so that input values within the same cluster are similar according to one or more (predefined) similarity criteria, while they are dissimilar to input values included in other clusters.

Reinforcement learning is a third group of machine learning algorithms. In other words, reinforcement learning may be used to train the machine learning model. In reinforcement learning, one or more software agents are trained to perform actions in an environment. A reward is calculated based on the actions performed. Reinforcement learning is based on training the one or more software agents to select the actions such that the cumulative reward is increased, resulting in software agents that become better at the task they are given (as evidenced by increasing rewards).

Furthermore, some techniques can be applied to some of the machine learning algorithms. For example, feature learning may be used. In other words, the machine learning model may be trained using feature learning, at least in part, and/or the machine learning algorithm may include a feature learning component. Feature learning algorithms, called representation learning algorithms, may receive the information in their input but transform it so that it becomes useful, often as a pre-processing stage before performing classification or prediction. Feature learning may, for example, be based on principal component analysis or cluster analysis.

In some examples, anomaly detection (that is, outlier detection) may be used, which aims to provide identification of input values that raise suspicion as being significantly different from the majority of input and training data. In other words, the machine learning model may be trained at least in part using anomaly detection, and/or the machine learning algorithm may include an anomaly detection component.

In some examples, the machine learning algorithm may use a decision tree as a prediction model. In other words, the machine learning model may be based on a decision tree. In a decision tree, the observations on an item (for example, a set of input values) may be represented by the branches of the decision tree, and an output value corresponding to the item may be represented by the leaves of the decision tree. Decision trees may support both discrete values and continuous values as output values. When discrete values are used, the decision tree may be called a classification tree; when continuous values are used, the decision tree may be called a regression tree.

Association rules are another technique that may be used in machine learning algorithms. In other words, the machine learning model may be based on one or more association rules. Association rules are created by identifying relationships between variables in large amounts of data. The machine learning algorithm may identify and/or utilize one or more ratio rules that represent knowledge derived from the data. The rules may be used, for example, to store, manipulate or apply the knowledge.

Machine learning algorithms are usually based on a machine learning model. In other words, the term “machine learning algorithm” may denote a set of instructions that may be used to create, train or use a machine learning model. The term “machine learning model” may denote a data structure and/or a set of rules representing the learned knowledge (for example, based on the training performed by the machine learning algorithm). In embodiments, the use of a machine learning algorithm may imply the use of an underlying machine learning model (or a plurality of underlying machine learning models). The use of a machine learning model may imply that the machine learning model and/or the data structure/set of rules forming the machine learning model is/are trained by a machine learning algorithm.

For example, the machine learning model may be an artificial neural network (ANN). ANNs are systems inspired by biological neural networks, such as those found in a retina or brain. ANNs include a plurality of interconnected nodes and a plurality of connections, called edges, between the nodes. There are usually three types of nodes, input nodes that receive input values, hidden nodes that are (only) connected to other nodes, and output nodes that provide output values. Each node may represent an artificial neuron. Each edge may send information, from one node to another. The output of a node may be defined as a (non-linear) function of the inputs (for example, the sum of its inputs). The inputs of a node may be used in the function based on a “weight” of the edge or node providing the input. The weight of nodes and/or edges may be adjusted in the learning process. In other words, training an artificial neural network may include adjusting the weights of the nodes and/or edges of the artificial neural network, that is, to achieve a desired output for a particular input.

Alternatively, the machine learning model may be a support vector machine, a random forest model or a gradient boosting model. Support vector machines (that is, support vector networks) are supervised learning models with associated learning algorithms that can be used to analyze data (for example, in a classification or regression analysis). Support Vector Machines may be trained by providing an input with a plurality of training input values belonging to one of two categories. The support vector machine may be trained to assign a new input value to one of the two categories. Alternatively, the machine learning model may be a Bayesian network, which is a probabilistic directed acyclic graph model. A Bayesian network may represent a set of random variables and their conditional dependencies using a directed acyclic graph. Alternatively, the machine learning model may be based on a genetic algorithm, which is a search algorithm and heuristic technique that mimics the process of natural selection.

### BRIEF DESCRIPTION OF DRAWINGS

The invention will now be described with reference to the drawings wherein:

FIG. 1 shows a method of generating 100 reference data according to embodiments of the disclosure;

FIG. 2 shows a method of controlling and/or performing feedback-control and/or inspecting 200 a manufacturing and/or assembly process according to embodiments of the disclosure;

FIG. 3 shows a method of generating 300 reference data with adjustments by a user according to embodiments of the disclosure;

FIG. 4 shows a monitoring system 400 in manufacture according to embodiments of the disclosure;

FIG. 5 shows a monitoring system 400 according to the embodiment shown in FIG. 4 for monitoring a manufacturing and/or assembly process for an assembled workpiece;

FIG. 6 shows layers 600 of a manufacturing and/or assembly process according to embodiments of the disclosure;

FIG. 7 shows a method of monitoring 700 using reference data according to embodiments of the disclosure;

FIG. 8 shows an embodiment 800 for generating reference data according to embodiments of the disclosure;

FIG. 9 shows an overview view of an embodiment 900 for using reference data for assembly inspection according to embodiments of the disclosure; and,

FIGS. 10A and B show an embodiment 1000 for using reference data for assembly inspection according to embodiments of the disclosure in an implementation view.

### DETAILED DESCRIPTION

In the following, embodiments of the disclosure are described in which a computer-implemented method of generating reference data for use in a manufacturing and/or assembly process is used.

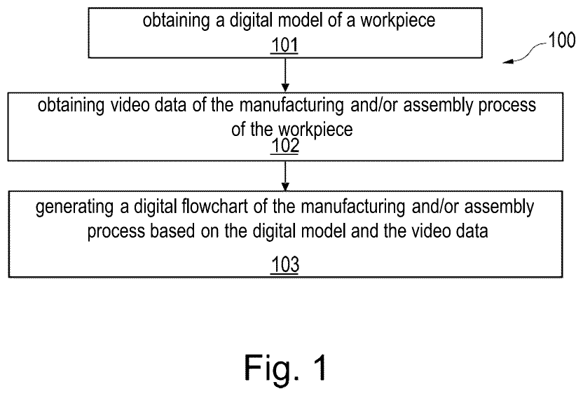

FIG. 1 shows a schematic representation of the method of generating 100 reference data according to embodiments of the disclosure.

In a first step of the method, a digital model of a workpiece is obtained 101. In a further step, the method includes obtaining video data 102 of the manufacturing and/or assembly process of the workpiece. Finally, in a further step, a digital flowchart 103 of the manufacturing and/or assembly process is generated based on the digital model and the video data.

The workpiece includes several components. The manufacturing and/or assembly process provides for the components to be arranged on top of each other and connected to each other via a plug connection provided on the components. The digital model is a CAD model that includes the geometric data of the components and their position in relation to each other. Furthermore, the components are detected by a camera. The video data detected by the camera is stored on a storage medium. In a further step, a digital flowchart of the manufacturing and/or assembly process is generated based on the digital model and the video data. The digital flowchart and/or the reference data may be generated in-line, that is, while the video data is being captured, and/or offline, that is, after the video data has been captured and stored. Offline processing is particularly useful for large amounts of data.

After the geometric data of the components has been detected by the CAD model, it may advantageously be used when obtaining 102 the video data. Accordingly, when obtaining 102 the video data, in particular the position of the components is detected.

Generating 103 the digital flowchart is performed using a machine learning model.

In a further step, the digital flowchart is made available to a plurality of different robot systems. Some of the robot systems are equipped with one robot arm, while other robot systems have two or more robot arms. Each robot system may translate the digital flowchart into reference data and a route description. The reference data and the path description are machine-specific. The digital flowchart, on the other hand, is a universal and machine-independent plan for the sequence of the manufacturing and/or assembly process. The method may ensure that each robot system arrives at the assembly destination in a way that is suitable for the respective robot system.

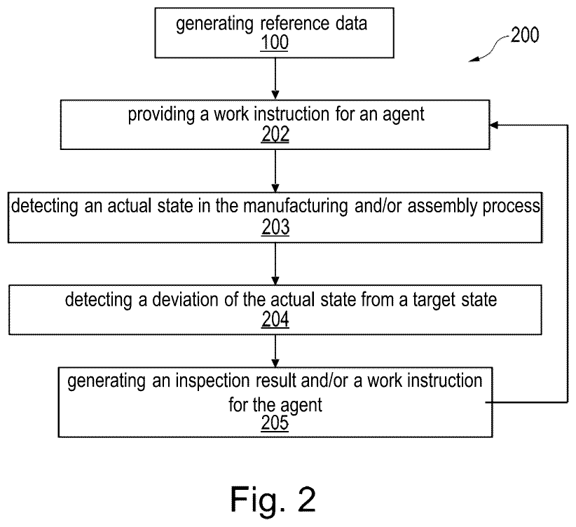

FIG. 2 shows a method of controlling and/or performing feedback-control and/or inspecting 200 a manufacturing and/or assembly process according to embodiments of the disclosure.

The first step is generating 100 reference data.

In a second step, there is performed providing 202 a work instruction for an agent. The agent includes a robot system that may execute the work instruction. It is checked in advance whether the robot system has the necessary degrees of freedom to be able to carry out the work instruction.

In a third step, there is performed detecting 203 an actual state of the manufacturing and/or assembly process. The detecting 203 of the actual state is based on video data of the manufacturing and/or assembly process.

In a fourth step, there is performed detecting 204 a deviation of the actual state from a target state. The target state has reference data for the manufacturing and/or assembly process. The reference data includes a digital flowchart.

In a fifth step, there is performed generating 205 an inspection result and/or a work instruction for the agent. The generated work instruction can then be used for providing 202 the work instruction for the agent in accordance with the second step. The method thus forms a control loop.

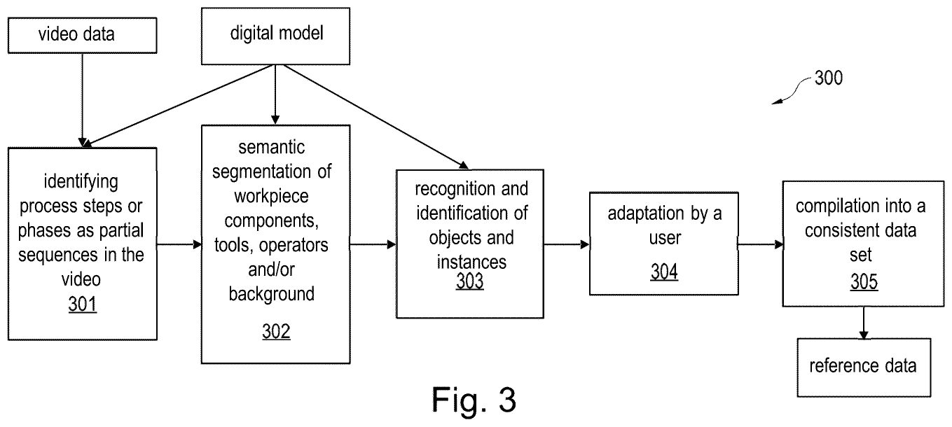

FIG. 3 shows a method of generating 300 reference data with adjustments by a user according to embodiments of the disclosure.

In a first step, there is performed identifying 301 process steps or phases as partial sequences in the video. A first identified process step may be a drilling process, for example, while a second identified process step is a screwing process. Video data and a digital model are available for the identification 301.

In a second step, a semantic segmentation 302 of workpiece components, tools, operators and/or background is performed. The type of tool used in the manufacturing process is detected. The tools may be a drill and a wrench, for example. The (respective) digital model is also used in this step.

In a third step, there is performed a recognition and identification 303 of objects and instances. Objects and instances include, inter alia, the workpiece and the tool components. Instances are several identical or similar objects, here, for example, several screws that are screwed together (one after the other). The digital model is also used in this step.

In a fourth step, there is provided an adaptation 304 by a user. The user is a machine operator with specialist knowledge of the manufacturing process. The user may, for example, correct the results of the first steps. For example, the user may correct the tool to be used or specify it in more detail. The user may also provide the process with further information, in particular information that cannot be detected by the video data.

In a fifth step, a compilation 305 of data into a consistent data set is performed. The data set includes the list of phases, tools, components and instructions.

Finally, reference data is generated from the consistent data set.

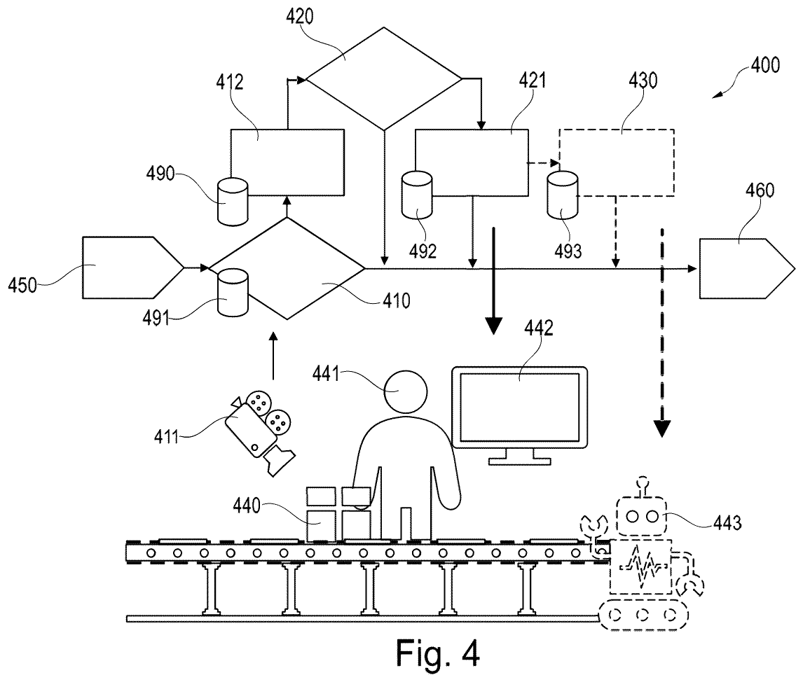

FIG. 4 shows a monitoring system 400 in manufacturing according to embodiments of the disclosure.

The monitoring system 400 is used between a first manufacturing process 450 and a second manufacturing process 460.

In a first step, the monitoring system 400 performs anomaly detection 410. For this purpose, video data of a workpiece 440 is detected via a camera 411. Furthermore, an evaluation 412 of a deviation of an actual state from a target state takes place. The target state includes reference data of the first manufacturing process 450 and the second manufacturing process 460.

In a second step, the monitoring system 400 carries out measures to eliminate the deviation. For this purpose, a necessity check 420 is first carried out to determine whether an action is necessary or not. If no action is necessary, a worker 441 is informed via a screen 442. If a measure is necessary, the type of measure is determined in a next step 421. The type of action is usually a corrective action on the workpiece 440. Once the type of action has been determined, the worker 441 is informed via the screen 442. The worker 441 then performs the corrective action on the workpiece 440.

Alternatively or additionally, the monitoring system 400 may carry out further corrective actions on the workpiece 440 via a robot system 443. The further corrective actions are, for example, actions that the worker 441 cannot perform manually, for example. It may also be a purely robotic correction, so that the correction is carried out automatically only and without a worker.

The workpiece 440 is then passed on to the second manufacturing process 460.

The monitoring system 400 includes databases 490, 491, 492, and 493 which are used in the monitoring process. The following information, or any combination thereof, may be stored in the databases: Patterns for detecting anomalies and/or irregularities (491), evaluation standards and/or metrics for quantifying a deviation (490), look-up tables for correcting specific deviations (492), tables or models for automated correction of deviations (493), that is, for performing the proposed corrective action. As a rule, the reference data described will also affect the respective databases and their information processing.

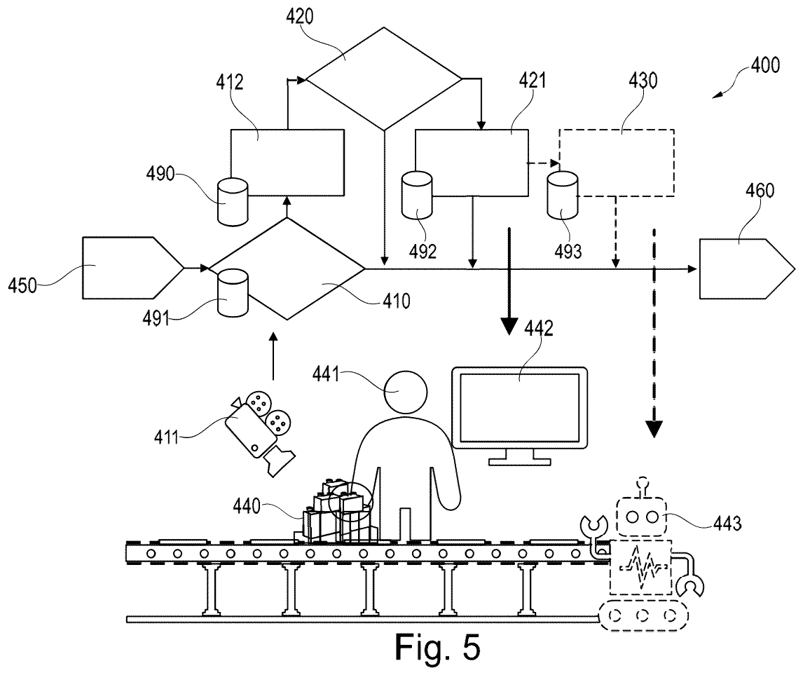

FIG. 5 shows the embodiment according to FIG. 4, wherein the monitoring system 400 monitors a manufacturing and/or assembly process and the workpiece 440 is an assembled workpiece.

The assembled workpiece includes several components arranged on top of each other. The components have different colors. The anomaly detection 410 is used to determine that a yellow component is incorrectly arranged and that the components are not correctly screwed together. The manufacturing and/or assembly process provides for a blue component instead of the yellow component. The measures are then determined and passed on to the worker 441 and the robot 443. The worker 441 provides the robot 443 with a blue component. In the next step, the robot 443 exchanges the yellow component for the blue component.

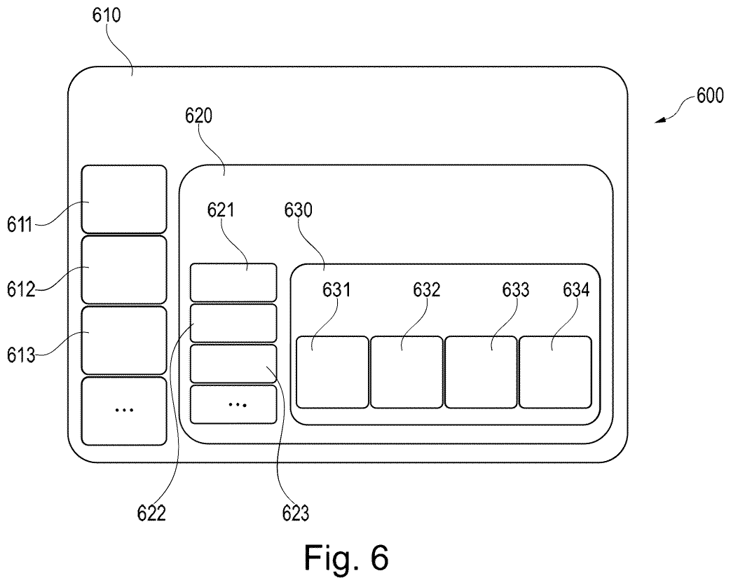

FIG. 6 shows various levels of complexity 600 at which the aspects of the disclosure may be applied in a manufacturing and/or assembly process according to embodiments of the disclosure. Different exemplary levels of complexity are shown here:

630 are purely static evaluations and/or comparisons (theoretically, a single image may be sufficient as a comparison).

620 are dynamic processes and/or evaluations (for this purpose, at least image sequences and/or videos must be used as a comparison, for example, also to monitor process times; for example: curing time for gluing process); 630 is a subset of 620.

In addition to assembly, 610 also includes processing operations (machining, forming, painting, et cetera); 620 is a subset of 610.

It should be emphasized that FIG. 6 only includes exemplary methods, processes and steps and that the list is not exhaustive.

The processes described herein may affect all levels 600. The levels 600 thereby include manufacturing processes 610, manufacturing and/or assembly processes 620, and manufacturing and/or assembly steps 630.

Manufacturing processes 610 include, in the example shown and without claiming to be exhaustive, forming techniques 611, cutting and separating 612, and coating 613. Manufacturing and/or assembly processes 620 in include, the example shown and without claiming to be exhaustive, handling 621, tool provision 622 and timing 623. Assembly steps 630 include, in the example shown and without claiming to be exhaustive, detection or inspection of the correct number and/or presence of the components 631, detection or inspection of the correct position of the parts relative to one another 632, detection or inspection of the correctness of the components, in particular in the case of interchanging similar components 633, and documentation 634. The processing processes 610-613, manufacturing and/or assembly processes 620-623, and manufacturing and/or assembly steps 630-634 shown are merely exemplary and in other embodiments any other number of any other elements may be provided.

When inspecting or validating the manufacturing and/or assembly process 620, the methods described herein may be used in different ways. It is possible that an extension of the inspection of assembly steps is carried out by observing the process, the tools and the type of execution. During handling 621, observation of collision-free part movement may be carried out. During tool provision 622, the use of the correct tools and parameters may be ensured. The connection of a torque sensor for the screw connection, for example, is optional. With timing 623, the monitoring of the curing time or similar can be improved. The detection of subsequently invisible components or adhesives may also be part of the monitoring.

A stationary or mobile camera may be used to check and/or validate assembly steps 630.

A simultaneous feedback on observed deviations may be provided. For example, completeness may be observed by identifying missing components. Furthermore, the alignment may be observed by checking the plausibility of the component alignment. Finally, defects on visible components, in particular the surface or shape of the components, may also be observed.

Automatic documentation may also be performed. Intelligent data handling may be performed by automatically recognizing a product, assembly stage, and camera perspective.

Fast learning and adaptation to new assemblies may also be carried out. Reference data may be used, wherein the reference data is generated on the basis of CAD models of the assemblies and components, assembly plans, information on surface texture and/or shared databases of similar parts with “machine learning” (ML)-trained error detection (for example, surface).

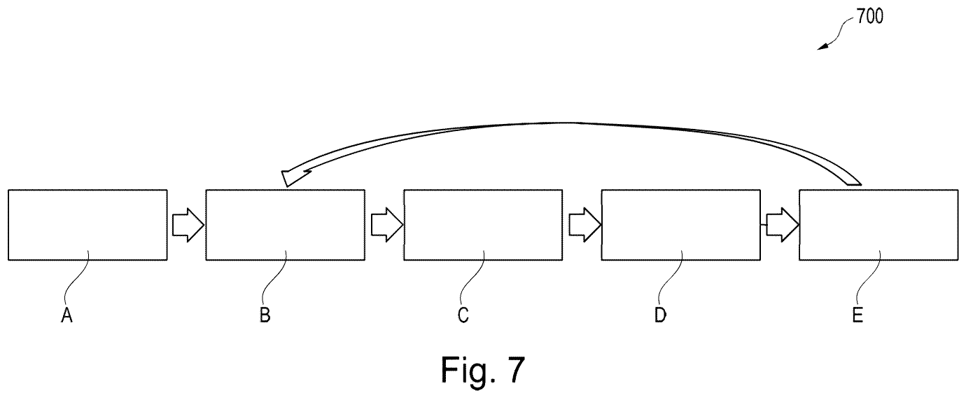

FIG. 7 shows a method of monitoring 700 via reference data according to embodiments of the disclosure.

In the first step A, reference data is prepared. In a second step B, an agent is given a task or work instruction, respectively. In a third step C, the current state or actual state is reconstructed with the help of sensors and data fusion. In the fourth step D, a comparison and evaluation of the actual state compared to the reference data is performed. In the fifth step E, system feedback is provided to the agent about the process that is performed.

It is possible for system feedback to be carried out during process execution (for example, step-by-step or continuous in-line control).

In a further embodiment of the disclosure, a person carries out an assembly in two main steps:
First main step: Part X is aligned with part Y, inserted and/or clicked into place
Second main step: Part X is attached to part Y (screwed and/or glued)

At least one camera detects the assembly process. This generates video data. CAD models of part X and Y are available in stored form. The video data is algorithmically processed offline to extract relevant information.

The following steps are carried out when processing the video data:
1. Objects (part A and part B), articles and persons are recognized in the video data
2. Recognition of assembly steps and phases and type
3. (Relative) position/pose of relevant parts and objects (tools) in relation to each other is detected and tracked
4. Saving the digital flowchart

Reference data is then visualized, checked for completeness, and supplemented. The reference data is used as a work instruction (“Content Creation for Augmented Reality”).

The reference data is also used to control robots. There are two implementation options.

The first implementation option provides an adaptive planning of the movement using the current or actual initial position. The first implementation option includes detection of the current poses of the objects, robot trajectory planning using these inputs, whereby the robot trajectory planning is dependent on the robot model, and grasp planning, possibly with extracted grasp points/strategy from reference data.

The second implementation option provides an imitation learning through further pre-processing of the reference data. In a first step, dynamic movement primitives are learned for each individual step of the assembly or assembly phase. Adaptive planning as in the first implementation option is not performed. Instead, a learned movement to a (relative) target is performed or imitated. The movement may be learned in such a way that the target goal state and a possible path to it (relative trajectory of two parts to be connected) are always executed in a similar way. The execution is thus independent of the starting point, that is, independent of where the parts are initially gripped. This type of movement is important and advantageous if two parts are to be aligned with each other in direction-specific manner, for example, if one part is to be inserted into the other with a specific movement, clicked together or joined from the correct direction in a similar way to clamping components.

A kinematics simulation is required to learn the robot's control parameters. The simulation is dependent on the robot model and may be fully automated (also offline before execution).

Both implementations may be preceded by a feasibility test to check whether the task may be implemented with the current conditions. It may be checked whether all the necessary components are available and accessible (within reach of the robot). Furthermore, it may be checked whether the payload and mobility (dexterity) of the robot is sufficient to find a solution.

In a further embodiment of the disclosure, the state is detected at the end of each individual step or phase. All individual components and their spatial relationship to one another are recognized.

The information on the construction status can be stored not only as an image or photo, but also as a sequence of the construction status in the digital 3D model or as a tree structure (assembly priority graph) with a clear sequence. Storage in digital form, for example, in XML file format or similar generic form, is also possible.

Deviations are then detected using the reference data, in particular the resulting geometric shape.

In a further step, a request is sent to the worker to keep the camera's line of sight clear if the building condition cannot be clearly observed or assessed. An assessment may also be carried out from another available perspective. It is also possible that a request is sent to the worker to make the construction status (in the critical area) accessible to the observation camera by repositioning.

In a further step, if a deviation is detected or verified, feedback is sent to the worker in the event of manual assembly. Markings of the deviation are displayed, for example, on a virtual model on a screen and/or using AR technology. It is also possible that a deviation marker is displayed on a real component using a projection unit at the assembly station. Furthermore, an indication for a rectification may be displayed. A rectification indication may refer to a missing component, a mixed-up component, and/or a shifted or twisted component position.

It is also possible for an adapted robot check to be carried out in the event of robotic assembly. In the event of an incorrect component, automated dismantling may be carried out until the last correct state is reached. The correct component is then installed.

If the position is incorrect, the fixture may be removed or released so that the component position may be corrected using grippers (robot trajectory planning, that is, via adaptive planning or imitation learning). If a component is missing, the corresponding assembly step may be repeated or completed. Sorting out is also possible if the adapted robot control is not possible or not successful.

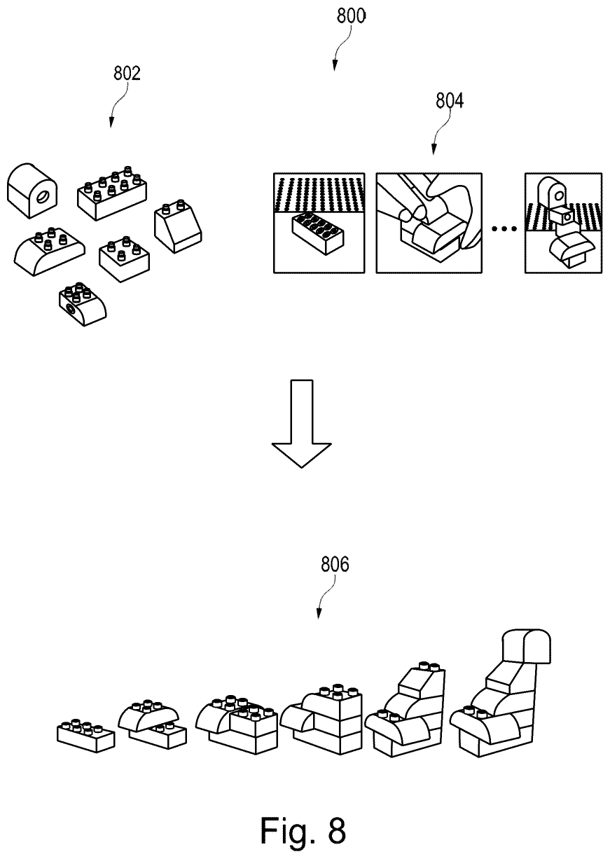

FIG. 8 shows a process for generating reference data using an embodiment 800.

The input data for the process is shown in the upper section of FIG. 8. The input data includes 3D models 802 of components and a video recording 804 of the manual assembly of the components. In the example shown, the components are clamping components.

From the input data 802 and 804, the process 800 generates reference data 806 as output, shown in the lower section of FIG. 8. In the example shown, the reference data 806 generated includes information on the identification of six successive assembly steps, each with an indication of which clamping component was installed in which step.

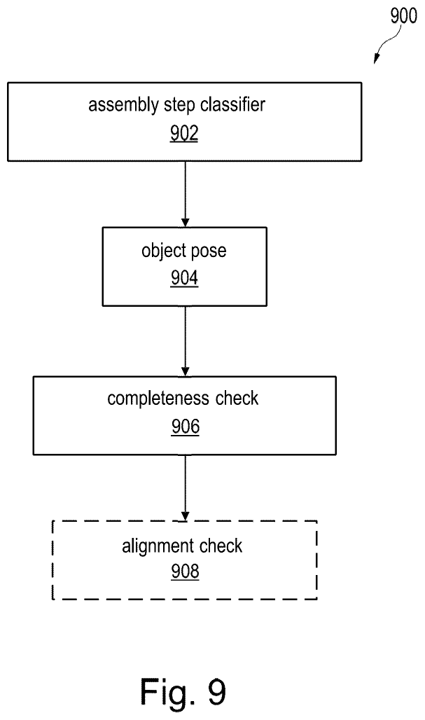

FIG. 9 shows an overview view of an embodiment 900 for using reference data for assembly inspection according to embodiments of the disclosure.

The module 902 is an assembly step classifier that can classify the steps and/or phases of the manufacturing and/or assembly process. The classifier outputs a probability of the process being in a specific step or phase. This means that it is known which step or phase the process is in.

The module 904 relates to the object pose. Here, the composite object is observed from one or more specific perspectives. This means that the pose or position of the composite object is known.

The information obtained from the modules 902 and 904 may be used as auxiliary information in subsequent evaluation steps.

The module 906 concerns a completeness check. Here, the expected components are compared with the components actually observed. As a result, it is known whether all components that should be visible from the current perspective are actually visible or not. This may be helpful for finding missing parts (so-called “sanity check”).

The module 908 is optional and concerns an alignment check. Here, the position and orientation of the edges and/or corners in three-dimensional space (or of a 2D projection) are compared with the target. As a result, it is known whether the alignment of the components is within a permissible range. This may be helpful for finding incorrectly aligned or mixed-up components.

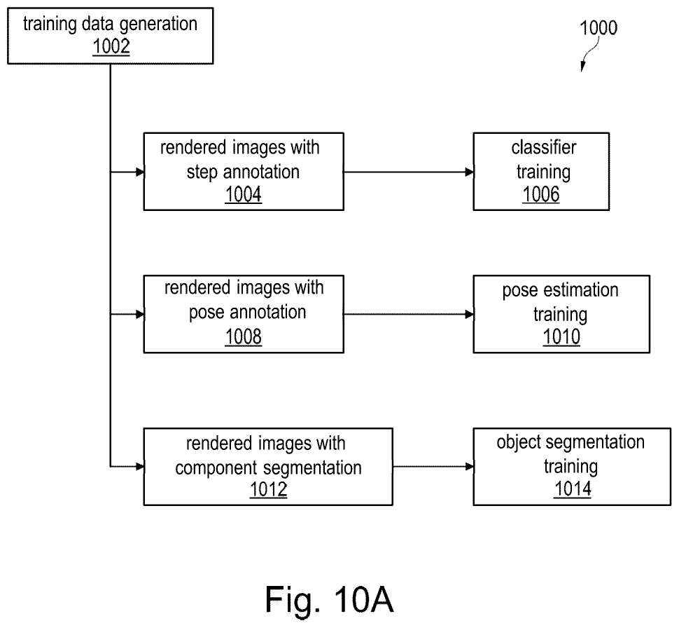

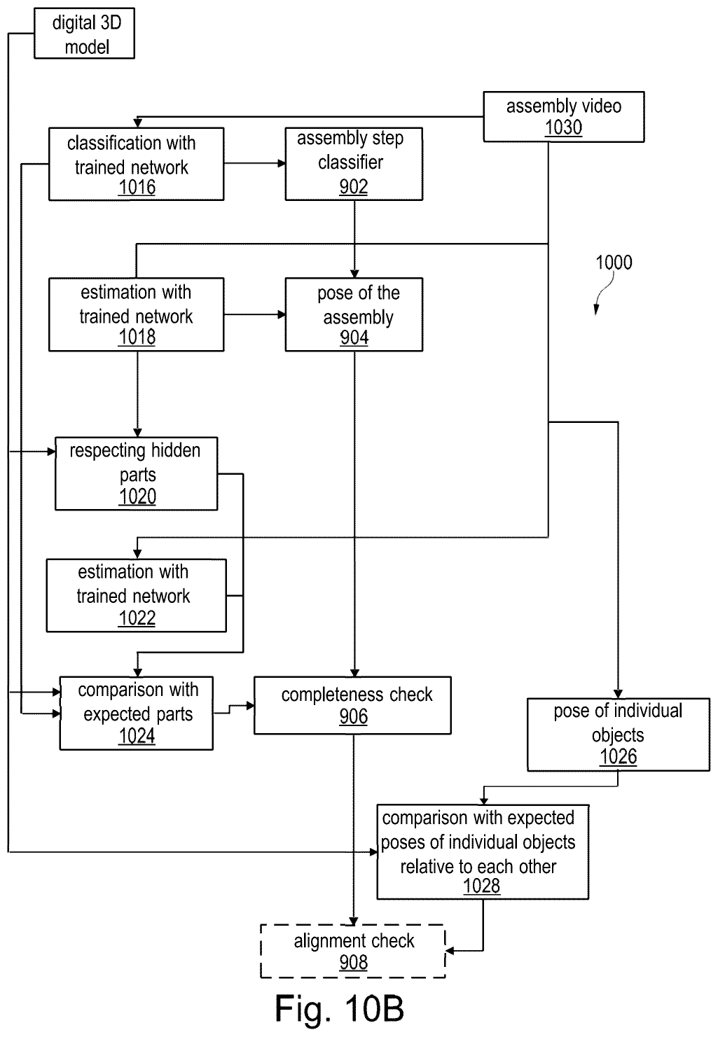

FIGS. 10A and 10B show an embodiment 1000 for using reference data for assembly inspection according to embodiments of the disclosure in an implementation view. The sub-process in FIG. 10A is typically performed offline, that is, in preparation for the actual runtime process in FIG. 10B.

In step 1002, training data is generated, preferably automatically. This may be done, for example, using suitable software tools such as Blender or Unreal Engine, as already described above. The input in step 1002 are composite CAD models for each step or phase. The output 1004, 1008, 1012 of step 1002 is synthetic and annotated image data from the rendering.

In step 1006, the classifier is trained with image data 1004 associated with step or phase annotations. The classifier may be, for example, a YOLO network. In step 1010, the pose estimation is trained with image data 1008 associated with pose annotations. This may be a so-called “single-shot” pose estimation (for example, Yolo_v6, PVNet). In step 1014, the object segmentation is trained with image data 1012 indicating a component segmentation. This may be, for example, a maskRCNN or ResNet.

With reference to FIG. 10B, the process at runtime is described below. In step 1016, the assembly video 1030 is classified using the network trained in step 1006. This represents an exemplary implementation of the assembly step classifier module 902 of FIG. 9. In step 1018, the object pose is estimated in the assembly video 1030 using the network trained in step 1010. This represents an exemplary implementation of the object pose module 904 of FIG. 9. In step 1022, the object segmentation is estimated in the assembly video 1030 using the network trained in step 1014. In step 1024, a comparison is made with the expected parts, whereby hidden parts (due to the perspective) are respected (step 1020). This represents an exemplary implementation of the completeness check module 906 of FIG. 9. In step 1026, a (precise) object pose estimation is performed based on the assembly video 1030. This may be done using template matching methods, for example. In step 1028, a comparison is made with the expected relative object poses. The training data generated in step 1002 may serve as (further) input for step 1028. This represents an exemplary implementation of the alignment check module 908 of FIG. 9. In addition, it may be advantageous to provide the 3D model of the assembly to steps 1020, 1024, and 1028 so that parts hidden in perspective may be determined correctly and purely analytically on the basis of the observation direction even without using a trained network.

Although some aspects have been described with reference to a device, modules and/or components, it is clear that these aspects also constitute a description of the corresponding method, wherein a block or device corresponds to a method step or a function of a method step. Similarly, aspects described in the context of a method step also constitute a description of a corresponding block or element or a feature of a corresponding device.

Embodiments of the disclosure may be implemented in a computing system. The computing system may be a local computing device (for example, personal computer, laptop computer, tablet computer, or cell phone) having one or more processors and one or more storage devices, or may be a distributed computing system (for example, a cloud computing system having one or more processors or one or more storage devices distributed at various locations, for example, at a local client and/or one or more remote server farms and/or data centers). The computing system may include any circuitry or combination of circuitry. In one embodiment, the computing system may include one or more processors, which may be of any type. As used herein, processor may mean any type of computing circuit, such as, but not limited to, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field-programmable gate array (FPGA), or any other type of processor or processing circuit. Other types of circuitry that may be included in the computing system may be a custom-built circuit, an application-specific integrated circuit (ASIC), or the like, such as one or more circuits (for example, a communication circuit) for use in wireless devices such as cellular phones, tablet computers, laptop computers, two-way radios, and similar electronic systems. The computing system may include one or more storage devices, which may include one or more storage elements suitable for the particular application, such as a main memory in the form of random access memory (RAM), one or more hard disks, and/or one or more drives that handle removable media, such as CDs, flash memory cards, DVDs, and the like. The computing system may also include a display device, one or more speakers, and a keyboard and/or controller, which may include a mouse, trackball, touch screen, voice recognition device, or any other device that allows a system user to input information to and receive information from the computing system.

Some or all of the method steps may be performed by (or using) a hardware device, such as a processor, a microprocessor, a programmable computer or an electronic circuit. In some embodiments, one or more of the main method steps may be performed by such a device.

Depending on certain implementation requirements, embodiments of the disclosure may be implemented in hardware or software. The implementation may be performed using a non-volatile storage medium such as a digital storage medium, such as a floppy disk, a DVD, a Blu-Ray, a CD, a ROM, a PROM and EPROM, an EEPROM or a FLASH memory, on which electronically readable control signals are stored that interact (or are capable of interacting) with a programmable computing system such that the particular method is performed. Therefore, the digital storage medium may be computer readable.

Some embodiments according to the disclosure include a data carrier having electronically readable control signals capable of interacting with a programmable computing system such that one of the methods described herein is performed.

In general, embodiments of the present disclosure may be implemented as a computer program product including a program code, wherein the program code is operative to execute one of the methods when the computer program product runs on a computer. For example, the program code may be stored on a machine-readable medium.

Further embodiments include the computer program for performing any of the methods described herein stored on a machine-readable medium.

In other words, an embodiment of the present disclosure is therefore a computer program including a program code for performing any of the methods described herein when the computer program runs on a computer.

Thus, another embodiment of the present disclosure is a storage medium (or a data carrier or computer readable medium) including a computer program stored thereon for executing one of the methods described herein when executed by a processor. The data carrier, digital storage medium or recorded medium is generally tangible and/or non-transitory. Another embodiment of the present disclosure is an apparatus as described herein including a processor and the storage medium.

Thus, another embodiment of the disclosure is a data stream or signal sequence representing the computer program for performing one of the methods described herein. The data stream or signal sequence may, for example, be configured to be transmitted over a data communication link, for example over the Internet.

Another embodiment includes a processing means, for example a computer or programmable logic device, configured or adapted to perform any of the methods described herein.

Another embodiment includes a computer on which the computer program for performing any of the methods described herein is installed.

Another embodiment according to the disclosure includes a device or system configured to transmit (for example, electronically or optically) a computer program for performing any of the methods described herein to a receiver. The receiver may be, for example, a computer, a mobile device, a storage device, or the like. The device or system may include, for example, a file server for transmitting the computer program to the receiver.

In some embodiments, a programmable logic device (for example, a field programmable gate array, FPGA) may be used to perform some or all of the functionalities of the methods described herein. In some embodiments, a field programmable gate array may cooperate with a microprocessor to perform any of the methods described herein. In general, the methods are preferably performed by any hardware device.

It is understood that the foregoing description is that of the preferred embodiments of the invention and that various changes and modifications may be made thereto without departing from the spirit and scope of the invention as defined in the appended claims.

1. A computer-implemented method of generating reference data for at least one of a manufacturing process and an assembly process, the method comprising:
obtaining a digital model of a workpiece;
obtaining video data of the at least one of the manufacturing process and the assembly process of the workpiece; and,
generating a digital flowchart of the at least one of the manufacturing and the assembly process based at least in part on the digital model and the video data.

2. The method of claim 1, wherein said generating the digital flowchart includes at least one of:
identifying a plurality of process steps of the at least one of the manufacturing process and assembly process based at least in part on the video data;
segmenting the video data to obtain information including at least one of:
information about the workpiece;
information about at least one component of the workpiece;
information about at least one executed process step;
information about at least one tool used;
information about at least one agent participating in the at least one of the manufacturing and the assembly process; and,
information about a background displayed in the video data.

3. The method of claim 1, wherein the digital model is at least one of a 3D model and a CAD model.

4. The method of claim 1, wherein the workpiece is a composite workpiece.

5. The method of claim 2, wherein said segmenting is semantic segmenting.

6. The method of claim 2, wherein said video data is segmented using the digital model of the workpiece.

7. A computer-implemented method of controlling and/or performing feedback-control and/or inspecting at least one of a manufacturing process and an assembly process, the method comprising:
detecting an actual state in the at least one of the manufacturing process and the assembly process based at least in part on video data of the at least one of the manufacturing process and assembly process;
recognizing a deviation of an actual state from a target state, wherein the target state includes reference data for the at least one of the manufacturing process and the assembly process and the reference data includes a digital flowchart;
generating at least one of an inspection result and a work instruction for an agent;
wherein the digital flowchart is generated by:
obtaining a digital model of a workpiece;
obtaining video data of the at least one of the manufacturing process and the assembly process of the workpiece; and,
generating the digital flowchart of the at least one of the manufacturing and the assembly process based at least in part on the digital model and the video data.

8. A computer-implemented method of creating an augmented reality environment, wherein the augmented reality environment is created based on reference data and the reference data includes the digital flowchart generated according to the method of claim 1.

9. The computer-implemented method of claim 7 further comprising obtaining additional data.

10. The method of claim 1 further comprising adapting the digital flowchart by a user.

11. The method of claim 1 further comprising generating an animation based on the digital flowchart.

12. The method of claim 1 further comprising at least one of:
generating at least one control signal for controlling the at least one of the manufacturing process, an assembly system, a robot system; and,
controlling at least one of the manufacturing, the assembly system, the robotic system for at least one of manufacturing and assembling the workpiece using at least one of the digital flowchart and the at least one control signal.

13. The method of claim 1, wherein said generating the digital flowchart includes at least one of:
identifying a plurality of process steps of the manufacturing and/or assembly process based at least in part on the video data and based on the digital model of the workpiece;
segmenting the video data to obtain information including at least one of:
information about the workpiece;
information about at least one component of the workpiece;
information about at least one executed process step;
information about at least one tool used;
information about at least one agent participating in the at least one of the manufacturing and the assembly process; and,
information about a background displayed in the video data.

14. A computer program comprising:
instructions for generating reference data for at least one of a manufacturing process and an assembly process, said instructions being stored on a non-transitory computer readable medium;
said instructions being configured, when the program is executed by a computer, to cause the computer to:
obtain a digital model of a workpiece;
obtain video data of the at least one of the manufacturing process and the assembly process of the workpiece; and,
generate a digital flowchart of the at least one of the manufacturing and the assembly process based at least in part on the digital model and the video data.

15. An apparatus or system for data processing, comprising means for carrying out the method of claim 1.
